(19) United States
(12) Patent Application Publication
(10) Pub. No.: US 2020/0204688 A1
(43) Pub. Date: Jun. 25, 2020

(54) PICTURE BOOK SHARING METHOD AND APPARATUS AND SYSTEM USING THE SAME

(71) Applicant: UBTECH ROBOTICS CORP LTD, Shenzhen (CN)

(72) Inventors: LIANGLIANG JIA, Shenzhen (CN); Youjun Xiong, Shenzhen (CN); Xuefeng Liang, Shenzhen (CN)

(21) Appl. No.: 16/669,549

(22) Filed: Oct. 31, 2019

(30) Foreign Application Priority Data
Dec. 25, 2018 (CN) 2018115880534

(51) Int. Cl. H04N 1/00; G06F 16/583; G06F 16/182; G06F 16/532; G06F 16/51

(52) U.S. Cl. CPC H04N 1/00159; G06F 16/5846; G06F 16/51; G06F 16/532; G06F 16/1824

(57) ABSTRACT

The present disclosure provides a picture book sharing method as well as an apparatus and a system using the same. The method includes: receiving, through a server node, an upload request for data of the picture book from a first client; storing the pictures and the audios in the data of the picture book to a file storage server, and obtaining storage addresses of the pictures and the audios; creating an index for the storage addresses and the texts in the data of the picture book, and storing the index and the texts in the data of the picture book to a search server; and searching for the texts corresponding to the picture book requested by a search request from a second client, obtaining the pictures and the audios corresponding to the texts according to the index, and transmitting the obtained texts, pictures and audios to the second client.

### CROSS REFERENCE TO RELATED APPLICATIONS

This application claims priority to Chinese Patent Application No. 201811588053.4, filed Dec. 25, 2018, which is hereby incorporated by reference herein as if set forth in its entirety.

### BACKGROUND

### 1. Technical Field

The present disclosure relates to Internet technology, and particularly to a picture book sharing method as well as an apparatus and a system using the same.

### 2. Description of Related Art

With the development of technology, the functions of electronic devices are becoming more and more diversified, which brings great convenience to people's life and work. Through electronic devices such as smart phones, the user can perform online payment, reservation service, mail transmission and reception, real-time communication, and the like, and the electronic devices have gradually become a kind of daily use tool that people rely on very much.

Today, when electronic devices are frequently used, the user also often uses electronic devices to access picture book resources. However, since the access of the picture book resources are usually realized by scanning a picture book to obtain the pictures and the pictures are store in a server for access, which is cumbersome and the user cannot upload, query and read the required picture resource quickly and efficiently.

### BRIEF DESCRIPTION OF THE DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments of the present disclosure. For those skilled in the art, other drawings can be obtained according to the drawings without creative efforts.

FIG. 1 is a flow chart of an embodiment of a picture book sharing method according to the present disclosure.

FIG. 2 is a flow chart of a process for speeding up data obtaining efficiency of a picture book according to an embodiment of the present disclosure.

FIG. 3 is a schematic block diagram of an embodiment of a picture book sharing apparatus according to the present disclosure.

FIG. 4 is a schematic block diagram of an embodiment of a picture book sharing system according to the present disclosure.

FIG. 5 is a schematic block diagram of an embodiment of a picture book sharing server according to the present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

For the purpose of describing the technical solutions of the present disclosure, the following describes through specific embodiments.

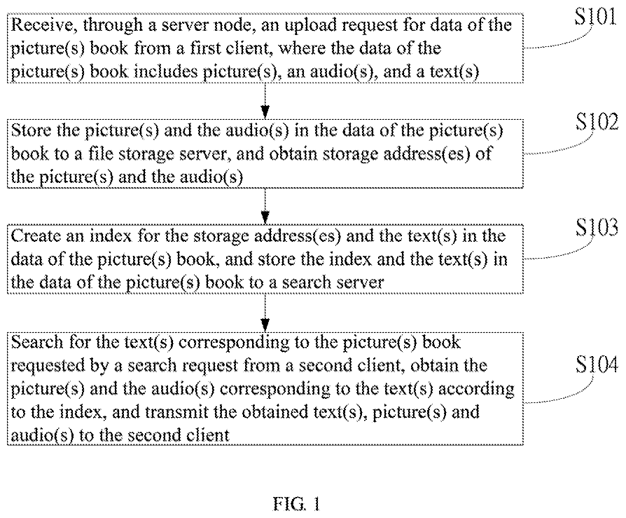

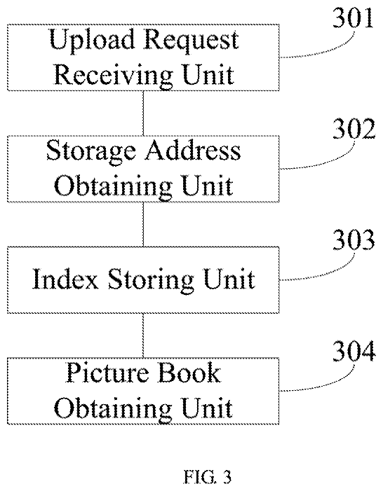

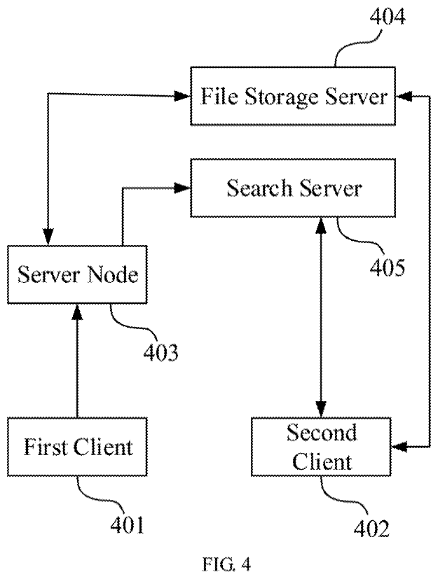

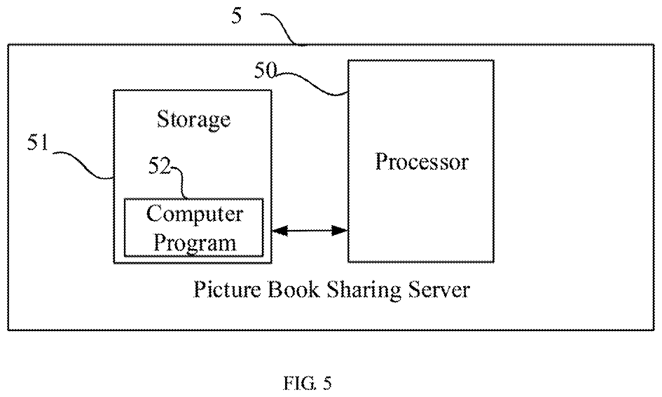

FIG. 1 is a flow chart of an embodiment of a picture book sharing method according to the present disclosure. In this embodiment, a picture book sharing method (e.g., a humanoid robot) composed of a plurality of assemblage parts is provided. The method is a computer-implemented method executable for a processor, which may be implemented through and applied to a picture book sharing apparatus as shown in FIG. 3, a picture book sharing system as shown in FIG. 4, or a picture book sharing server as shown in FIG. 5, or implemented through a computer readable storage medium. As shown in FIG. 1, the method includes the following steps.

S101: receiving, through a server node, an upload request for data of the picture book from a first client, where the data of the picture book includes picture(s), audio(s), and text(s).

In this embodiment, the server node can be used to collect the data of the picture book, store the collected data of the picture book to the file storage server according to data type (e.g., picture, audio, and text), and obtain the storage address of the stored file, so as to facilitate the download of the required file according to the storage address in the subsequent obtaining of the storage file.

The server node can include a plurality of server nodes for receiving the data of the picture book transmitted by the first client. In the case that a server node is crashed, other server nodes can still normally receive the data of the picture book uploaded by the first client.

The data of the picture book can include texts, audios, and pictures. In which, the texts can be the content in the picture book, and can be obtained by digitizing the characters in the picture book; the audios can be in a format of MP3 or the like; and the pictures can be illustrations in the picture book.

The amount of the server node can be determined according to registrations. In the case that the amount of the users simultaneously uploading the data of the picture book at the same time is large, the amount of the server nodes can be increased; and in the case that the amount of the users simultaneously uploading the data of the picture book is small, the amount of the server nodes can be reduced. The amount of the server nodes can be increased and decreased by registering and deregistering with the distributed coordination server. Therefore, the efficiency the server node to collect the data of the picture book can be effectively improved. The distributed coordination server can be a Zookeeper distributed coordination server.

S102: storing the picture and the audio in the data of the picture book to a file storage server, and obtaining storage address(es) of the picture(s) and the audio(s).

Since the audios and the pictures will occupy a large storage space, and the possibility to search the data of the picture book directly through the audio comparison and the picture comparison is small, the pictures and audios in the data of the picture book can be stored in the file storage server. In order to facilitate file access and improve file access efficiency, the file storage serve can be a distributed file storage server such as fast DFS. After the server node stores the pictures and audios in the data of the picture hook in the file storage server, the storage addresses of the pictures and that of the audios can be returned. In one embodiment, the picture and the audio can also be stored in the same storage space, and a unique storage address can be returned.

S103: creating an index for the storage address(es) and the text(s) in the data of the picture book, and storing the index and the text(s) in the data of the picture book to a search server.

After obtaining the storage addresses of the pictures and the audios, the index for the storage addresses and the texts in the data of the picture book (i.e., information of the picture book) is created. In which, the text in the data of the picture book includes the texts of the picture book. In addition, the index is stored in the search server. The search server can be a distributed search server such as an Elastic Search server.

The texts in the data of the picture book may further include one or more of picture book name (s), picture book label(s), and picture book series. The picture book label can be set by the first client that uploads the picture book, or can be determined and updated based on the keyword that is extracted from the comments of the reader of the picture book. The picture book series is the category of the picture book such as a bilingual series and a science series.

S104: searching for the text(s) corresponding to the picture book requested by a search request from a second client, obtaining the picture(s) and the audio(s) corresponding to the text(s) according to the index, and transmitting the obtained text(s), picture(s) and audio(s) to the second client.

When the user inputs a keyword to search, the texts including the keyword can be found in the search server, and the storage addresses of the pictures and audios of the picture book corresponding to the texts can be found according to the stored index. The storage addresses of the picture and audio of the picture book can be transmitted by the search server to the second client, and the second client downloads the audios and pictures according to the storage addresses, so as to play the audios, the pictures, the corresponding text contents, and the like on the second client. Different terminals such as Apple system, Android system, WEB terminal or robot terminal can transmit the search request to the search server to provide diversification of terminal access.

In which, the first client and the second client can be the same client or different clients.

In this embodiment, it uploads the data of the picture book through the audios, the pictures and the texts, and creates the index of the text in the data of the picture book and the storage addresses, so that the uploading and searching of the pictures and the audios can be more efficient, and the convenience for the use of the user is improved.

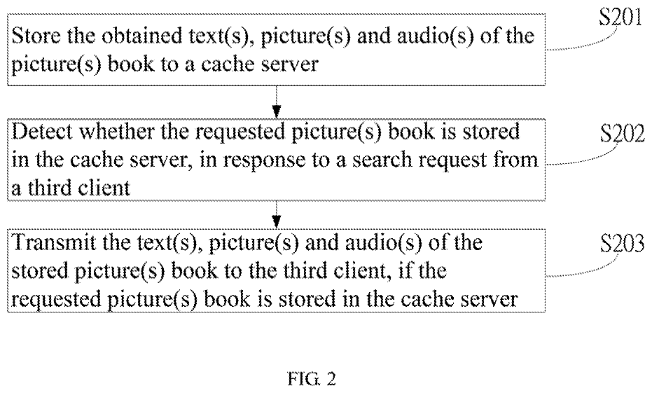

In one embodiment, after the second client transmits the search request and obtains the data of the picture book, the method may further include the step of caching (buffering) the data of the picture book which is for speeding up data obtaining efficiency of the picture book. FIG. 2 is a flow chart of a process for speeding up data obtaining efficiency of a picture book according to an embodiment of the present disclosure. As shown in FIG. 2, including:

S201: storing the obtained text(s), picture(s) and audio(s) of the picture book to a cache server.

The cache server can be determined based on the location of the second client. That is, the cache server that is closer to the second client can be selected. The cache server can be a distributed cache server such as a Redis cache server.

S202: detecting whether the requested picture book is stored in the cache server, in response to a search request front a third client.

S203: transmitting the text(s), picture(s) and audio(s) of the stored picture book to the third client, if the requested picture book is stored in the cache server.

In the cache server, the texts in the data of the picture book, the pictures, and the audios can be stored. When the search request transmitted by the third client matches the texts in the data of the picture book, the data of the corresponding picture book that is cached in the cache server can be directly transmitted to the third client, thereby greatly improve the efficiency of the third client to obtain the data of the picture book.

In which, the third client can be the same as the first client and/or the second client.

It should be understood that, the sequence of the serial number of the steps in the above-mentioned embodiments does not mean the execution order while the execution order of each process should be determined by its function and internal logic, which should not be taken as any limitation to the implementation process of the embodiments.

FIG. 3 is a schematic block diagram of an embodiment of a picture book sharing apparatus according to the present disclosure. In this embodiment, a picture book sharing apparatus is provided. The picture book sharing apparatus corresponds to the above-mentioned picture book sharing method of FIG. 1. As shown in FIG. 3, the picture book sharing apparatus includes:

an upload request receiving unit 301 configured to receive, through a server node, an upload request for data of the picture book from a first client, where the data of the picture book includes picture(s), audio(s), and text(s);

a storage address obtaining unit 302 configured to store the picture and the audio in the data of the picture book to a file storage server, and obtain one or more storage addresses of the picture and the audio;

an index storing unit 303 configured to create an index for the one or more storage addresses and the text(s) in the data of the picture book, and store the index and the text(s) in the data of the picture book to a search server; and

a picture book obtaining unit 304 configured to search for the text corresponding to the picture book requested by a search request from a second client, obtain the picture and the audio corresponding to the text according to the index, and transmit the obtained text, picture and audio to the second client.

The picture book sharing apparatus of FIG. 3 corresponds to the picture book sharing method of FIG. 1.

In this embodiment, each of the above-mentioned modules/units is implemented in the form of software, which can be computer program(s) stored in a memory of the picture book sharing apparatus and executable on a processor of the picture book sharing apparatus. In other embodiments, each of the above-mentioned modules/units may be implemented in the form of hardware (e.g., a circuit of the picture book sharing apparatus which is coupled to the processor of the impedance control apparatus) or a combination of hardware and software (e.g., a circuit with a single chip microcomputer).

FIG. 4 is a schematic block diagram of an embodiment of a picture book sharing system according to the present disclosure. As shown in FIG. 4, the picture book sharing system includes a first client 401, a second client 402, a server node 403, a file storage server 404, and a search server 405, where:

the server node 403 receives an upload request for data of a picture book from the first client 401; stores picture(s) and audio(s) in the data of the picture book to the file storage server 404, and obtains storage addresses(es) of the picture(s) and the audio(s) in the file storage server 404; creates an index for the storage addresses(s) and the text(s) in the data of the picture book, and stores the text(s) in the data of the picture book and the index to the search server 405; searches for the text(s) corresponding to the picture book according to a search request when the second client 402 transmits the search request to the search server 405; obtains the picture(s) and the audio(s) corresponding to the picture book according to the storage addresses(es) in the index, and transmits the obtained picture(s), audio(s), and text(s) of the picture book to the second client 402.

In one embodiment, the picture book sharing system further includes a cache server, where the cache server is configured to store the data of the picture book searched by the second client, detects whether the requested picture book is stored in the cache server when the search request is received from the third client, and transmits the text, the picture, and the audio of the stored picture book to the third client in response to the requested picture book being stored in the cache server.

The picture book sharing system of FIG. 4 corresponds to the picture book sharing method of FIG. 1.

FIG. 5 is a schematic block diagram of an embodiment of a picture book sharing server according to the present disclosure. As shown in FIG. 5, in this embodiment, the picture book sharing server 5 includes a processor 50, a storage 51, and a computer program 52 stored in the storage 51 and executable on the processor 50, for example, a picture book sharing program. When executing (instructions in) the computer program 52, the processor 50 implements the steps in the above-mentioned embodiments of the picture book sharing method. Alternatively, when the processor 50 executes the (instructions in) computer program 52, the functions of each module/unit in the above-mentioned device embodiments are implemented.

Exemplarily, the computer program 52 may be divided into one or more modules/units, and the one or more modules/units are stored in the storage 51 and executed by the processor 50 to realize the present disclosure. The one or more modules/units may be a series of computer program instruction sections capable of performing a specific function, and the instruction sections are for describing the execution process of the computer program 52 in the picture book sharing server 5. For example, the computer program 52 can be divided into:

an upload request receiving unit configured to receive, through a server node, an upload request for data of the picture book from a first client, where the data of the picture book includes picture(s), audio(s), and text(s);

a storage address obtaining unit configured to store the picture and the audio in the data of the picture book to a file storage server, and obtain storage address(es) of the picture and the audio;

an index storing unit configured to create an index fir the storage address(es) and the text(s) in the data of the picture book, and store the index and the text(s) in the data of the picture book to a search server; and

a picture book obtaining unit configured to search for the text corresponding to the picture book requested by a search request from a second client, obtain the picture and the audio corresponding to the text according to the index, and transmit the obtained text, picture and audio to the second client.

The picture book sharing server 5 may be a computing device such as a desktop computer, a notebook computer, a tablet computer, and a cloud server. The picture book sharing server 5 may include, but is not limited to, the processor 50 and the storage 51. It can be understood by those skilled in the art that FIG. 5 is merely an example of the picture book sharing server 5 and does not constitute a limitation on the picture book sharing server 5, and may include more or fewer components than those shown in the figure, or a combination of some components or different components. For example, the picture book sharing server 5 may further include an input/output device, a network access device, a bus, and the like.

The processor 50 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 51 may be an internal storage unit of the picture book sharing server 5, for example, a hard disk or a memory of the picture book sharing server 5. The storage 51 may also be an external storage device of the picture book sharing server 5, for example, a plug-in hard disk, a smart media card (SMC), a secure digital (SD) card, flash card, and the like, which is equipped on the picture book sharing server 5. Furthermore, the storage 51 may further include both an internal storage unit and an external storage device, of the picture hook sharing server 5. The storage 51 is configured to store the computer program 52 and other programs and data required by the picture book sharing server 5. The storage 51 may also be used to temporarily store data that has been or will be output.

Those skilled in the art may clearly understand that, tot the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus/system and method may be implemented in other manners. For example, the above-mentioned apparatus/system embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented method for sharing a picture book, comprising executing on a processor steps of:
receiving, through a server node, an upload request for data of the picture book from a first client, wherein the data of the picture book comprises one or more pictures, one or more audios, and one or more texts;
storing the picture and the audio in the data of the picture hook to a file storage server, and obtaining one or more storage addresses of the picture and the audio;
creating an index for the one or more storage addresses and the one or more texts in the data of the picture book, and storing the index and the text in the data of the picture book to a search server; and
searching for the text corresponding to the picture book requested by a search request from a second client, obtaining the picture and the audio corresponding to the text according to the index, and transmitting the obtained text, picture and audio to second client.

2. The method of claim 1, further comprising:
storing the obtained text, picture and audio of the picture book to a cache server;
detecting whether the requested picture book is stored in the cache server, in response to a search request from a third client; and
transmitting the text, picture and audio of the stored picture book to the third client, in response to the requested picture book being stored in the cache server.

3. The method of claim 2, wherein the one or more texts in the data of the picture book further comprises one or more of a picture book name, a picture book label, and a picture book series.

4. The method of claim 1, further comprising:
determining whether needs to add a new server node according to an amount of the upload requests of the first client; and
registering a new server node with a distributed coordination server in response to needing to add a new server node.

5. The method of claim 1, wherein after the step of receiving, through the server node, the upload request for the data of the picture book from the first client further comprises:
collecting the data of the picture book through two or more server nodes.

6. The method of claim 1, wherein the file storage server is a distributed file storage system, and the search server is a distributed search server.

7. An apparatus for sharing a picture book, comprising:
an upload request receiving unit configured to receive, through a server node, an upload request for data of the picture book from a first client, wherein the data of the picture book comprises one or more pictures, one or more audios, and one or more texts;
a storage address obtaining unit configured to store the picture and the audio in the data of the picture book to a file storage server, and obtain one or more storage addresses of the picture and the audio;
an index storing unit configured to create an index for the one or atone storage addresses and the one or more texts in the data of the picture book, and store the index and the text in the data of the picture book to a search server; and
a picture book obtaining unit configured to search for the text corresponding to the picture book requested by a search request from a second client, obtain the picture and the audio corresponding to the text according to the index, and transmit the obtained text, picture and audio to the second client.

8. A system for sharing a picture book, comprising a first client, a second client, a server node, a file storage server, and a search server, wherein:
the server node receives an upload request for data of the picture book from the first client; stores the picture and the audio in the data of the picture book to the file storage server, and obtains one or more storage addresses of the picture and the audio in the file storage server; creates an index for the one or more storage addresses and the one or more texts in the data of the picture book, and stores the text in the data of the picture book and the index to the search server; searches for the text corresponding to the picture book according to a search request when the second client transmits the search request to the search server; obtains the picture and the audio corresponding to the picture book according to the one or more storage addresses in the index, and transmits the obtained picture, audio, and text of the picture book to the second client.

9. The picture book sharing system according to claim 8, wherein the picture book sharing system further comprises a cache server, wherein the cache server is configured to store the data of the picture book searched by the second client, detects whether the requested picture book is stored in the cache server when the search request is received from the third client, and transmits the text, the picture, and the audio of the stored picture book to the third client in response to the requested picture book being stored in the cache server.
